(19) United States
(12) Patent Application Publication
(10) Pub. No.: US 2026/0370524 A1
(43) Pub. Date: Nov. 19, 2026

(54) WIRELESS COMMUNICATION SYSTEM, ANALYZER, WIRELESS COMMUNICATION METHOD AND ANALYSIS PROGRAM

(71) Applicant: NTT, Inc., Tokyo (JP)

(72) Inventors: Hiroyuki FURUYA, Musashino-shi, Tokyo (JP); Takeshi ONIZAWA, Musashino-shi, Tokyo (JP); Toshifumi MIYAGI, Musashino-shi, Tokyo (JP)

(73) Assignee: NTT, Inc., Tokyo (JP)

(21) Appl. No.: 19/478,296

(22) PCT Filed: May 25, 2023
(86) PCT No.: PCT/JP2023/019550

§ 371 Date: Oct. 24, 2025

(51) Int. Cl. H04L 27/14

(52) U.S. Cl. CPC H04L 27/14

(57) ABSTRACT

The wireless communication system includes the first wireless station, the second wireless station that performs wireless communication with the first wireless station by continuous radio waves, and an analyzer. At least one of the stations executes demodulating the received radio wave and notifying the analyzer of the temporal change pattern of the magnitude of the demodulation error as the demodulation error information. The analyzer executes storing a temporal change pattern of a radio signal in wireless packet communication that can interfere with wireless communication as a transmission pattern for each communication mode, comparing the demodulation error information with the transmission pattern, and estimating a communication mode having a transmission pattern having a high matching rate with the demodulation error information as a communication mode of a jamming wave for the wireless communication.

FIELD

The present disclosure relates to a wireless communication system, an analyzer, a wireless communication method, and an analysis program for detecting a jamming wave that jams wireless communication performed by the wireless communication system and estimating a communication mode of the jamming wave.

### BACKGROUND

As a method of detecting a jamming wave of wireless communication, a method of detecting destruction of received communication data, such as a cyclic redundancy check (CRC), is known. Alternatively, it is common to directly detect a jamming wave or power.

Patent Literature 1 discloses a wireless communication system including a radar/channel change detection circuit that detects an interference signal such as a radar signal or detects channel movement by detecting an interference signal such as a radar signal. As a result, it is possible to prevent a fatal traffic decrease for the user from occurring when an interference signal such as a radar signal is detected.

### CITATION LIST

### Patent Literature

Patent Literature 1: JP 2015-95838 A

### SUMMARY

### Technical Problem

However, in the above method, in a case where a jamming wave is detected, a communication mode of the jamming wave cannot be estimated.

In order to solve the above-described problem, the first object of the present disclosure is to provide a wireless communication system capable of estimating a communication mode of a jamming wave.

In addition, the second object is to provide an analyzer capable of estimating a communication mode of a jamming wave.

The third object is to provide a wireless communication method capable of estimating a communication mode of a jamming wave.

The fourth object is to provide an analysis program capable of estimating a communication mode of a jamming wave.

### Solution to Problem

According to a first aspect of the present disclosure, a wireless communication system includes:
the first wireless station;
the second wireless station configured to perform wireless communication with the first wireless station by a continuous wireless radio wave; and
an analyzer, in which
at least one of the first wireless station and the second wireless station is configured to execute:
demodulation processing of demodulating the received radio wave; and
notification processing of notifying the analyzer of a temporal change pattern of a magnitude of a demodulation error as demodulation error information, and
the analyzer is configured to execute:
processing of storing a temporal change pattern of a radio signal in wireless packet communication capable of interfering with the wireless communication as a transmission pattern for each communication mode;
comparison processing of comparing the demodulation error information with the transmission pattern; and
estimation processing of estimating a communication mode having a transmission pattern having a high matching rate with the demodulation error information as a communication mode of a jamming wave for the wireless communication.

According to a second aspect, an analyzer used together with two wireless stations that perform wireless communication by continuous radio waves, the analyzer is configured to execute:
processing of receiving, from at least one of the two wireless stations, a temporal change pattern of a magnitude of an error that occurs during demodulation of the radio wave as demodulation error information;
processing of storing a temporal change pattern of a radio signal in wireless packet communication capable of interfering with the wireless communication as a transmission pattern for each communication mode;
processing of comparing the demodulation error information with the transmission pattern; and
estimation processing of estimating a communication mode having a transmission pattern having a high matching rate with the demodulation error information as a communication mode of a jamming wave for the wireless communication.

According to a third aspect, a wireless communication method includes:
demodulating, by at least one of the first wireless station and the second wireless station that perform wireless communication with each other by continuous radio waves, the received radio wave;
notifying, by at least one of the first wireless station and the second wireless station, an analyzer of a temporal change pattern of a magnitude of a demodulation error as demodulation error information;
storing, by the analyzer, a temporal change pattern of a radio signal in wireless packet communication capable of interfering with the wireless communication as a transmission pattern for each communication mode;
comparing, by the analyzer, the demodulation error information with the transmission pattern; and
estimating, by the analyzer, a communication mode having a transmission pattern having a high matching rate with the demodulation error information as a communication mode of a jamming wave for the wireless communication.

According to a fourth aspect, an analysis program that causes an analyzer used together with two wireless stations that perform wireless communication by continuous radio waves to execute, the analysis program including a program that causes the analyzer to execute:
processing of receiving, from at least one of the two wireless stations, a temporal change pattern of a magnitude of an error that occurs during demodulation of the radio wave as demodulation error information;
processing of storing a temporal change pattern of a radio signal transmitted in wireless packet communication capable of interfering with the wireless communication as a transmission pattern for each communication mode;
processing of comparing the demodulation error information with the transmission pattern; and
estimation processing of estimating a communication mode having a transmission pattern having a high matching rate with the demodulation error information as a communication mode of a jamming wave for the wireless communication.

### Advantageous Effects of Invention

According to the first to fourth aspects of the present disclosure, it is possible to provide a wireless communication system, an analyzer, a wireless communication method, and an analysis program capable of estimating a communication mode of a jamming wave.

### BRIEF DESCRIPTION OF DRAWINGS

FIG. 1 is a diagram illustrating a configuration example of a wireless communication system according to the first embodiment.

FIG. 2 is a diagram for explaining a transmission mode of a radio wave according to the first embodiment.

FIG. 3 is a diagram for explaining a transmission mode of a jamming wave according to the first embodiment.

FIG. 4 is a schematic diagram illustrating a state in which a radio wave is demodulated in a case where interference of a jamming wave does not occur according to the first embodiment.

FIG. 5 is a schematic diagram illustrating a state in which a jamming wave and a radio wave including a jamming wave are demodulated according to the first embodiment.

FIG. 6 is a schematic diagram illustrating a state in which a jamming wave and a radio wave including a jamming wave are demodulated according to the first embodiment.

FIG. 7 is a transmission pattern of a radio signal of a communication mode A that can be a jamming wave for fixed wireless communication according to the first embodiment.

FIG. 8 is a transmission pattern of a radio signal of communication mode B that can be a jamming wave for fixed wireless communication according to the first embodiment.

FIG. 9 is a transmission pattern of a radio signal of communication mode C that can be a jamming wave for fixed wireless communication according to the first embodiment.

FIG. 10 is a schematic diagram illustrating demodulation error information of a radio wave according to the first embodiment.

FIG. 11 is a block diagram illustrating a configuration of a wireless communication system according to the first embodiment.

FIG. 12 is a block diagram illustrating a configuration of an analyzer according to the first embodiment.

FIG. 13 is a diagram illustrating a configuration example of a wireless communication system according to the second embodiment.

FIG. 14 is a diagram for explaining a relationship between a transmission mode of a jamming wave and content data according to the second embodiment.

FIG. 15 is a schematic diagram illustrating a relationship between a magnitude of a demodulation error and content data according to the second embodiment.

### DESCRIPTION OF EMBODIMENTS

A wireless communication system, an analyzer, a wireless communication method, and an analysis program according to embodiments of the present disclosure will be described with reference to the drawings. The same or corresponding components are denoted by the same reference signs, and repetition of the description may be omitted.

### First Embodiment

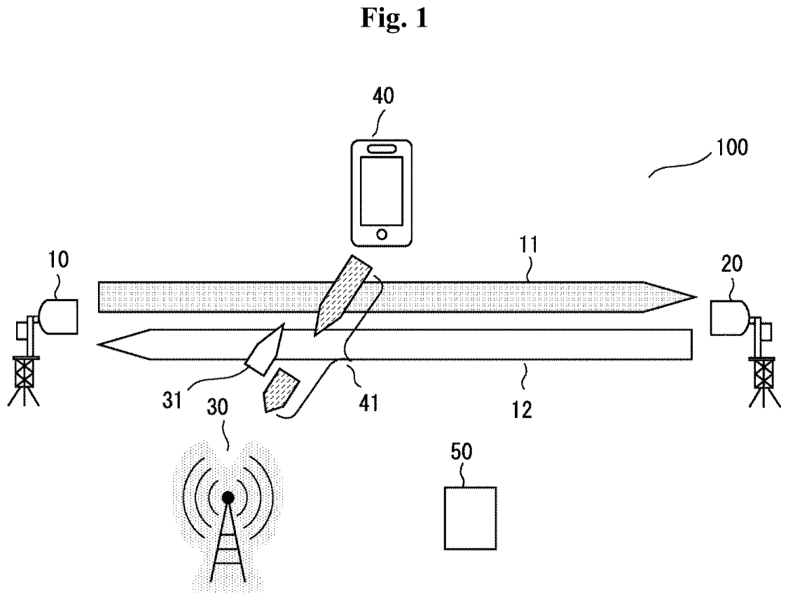

FIG. 1 is a diagram illustrating a configuration example of a wireless communication system 100 according to the first embodiment. The wireless communication system 100 includes the first wireless station 10 and the second wireless station 20.

The first wireless station 10 is fixedly used, converts a signal to be transmitted into a radio wave 11, and transmits the radio wave to the second wireless station 20. In addition, the first wireless station 10 receives a radio wave 12 transmitted from the second wireless station 20. The first wireless station 10 is a base station installed on a utility pole, a rooftop of a building, or the like, a relay station equipped with a parabolic antenna installed on a mountain, or the like.

The second wireless station 20 is fixedly used, and performs wireless communication with the first wireless station 10. The second wireless station 20 is a subscriber station installed in a house or the like, the above-described relay station, or the like.

Hereinafter, wireless communication performed by the first wireless station 10 and the second wireless station 20 is referred to as fixed wireless communication. Note that, the fixed wireless communication is not limited to communication using a known fixed wireless access link. In the present disclosure, wireless communication using continuous radio waves between fixedly used wireless stations is collectively referred to as fixed wireless communication.

The first jamming wireless station 30 establishes a mobile wireless link with the second jamming wireless station 40. The wireless communication performed here is wireless packet communication such as wireless local area network (LAN) communication. The first jamming wireless station 30 is, for example, a base station of the wireless LAN. The second jamming wireless station 40 is, for example, a mobile terminal such as a smartphone.

The radio waves transmitted and received between the first jamming wireless station 30 and the second jamming wireless station 40 interfere with the fixed wireless communication described above. Therefore, hereinafter, the radio wave transmitted by the first jamming wireless station 30 is referred to as a jamming wave 31, and the radio wave transmitted by the second jamming wireless station 40 is referred to as a jamming wave 41.

In a case where the jamming wave 31 or the jamming wave 41 is detected in the demodulation of the radio wave 12, the first wireless station 10 notifies an analyzer 50 of demodulation error information 5. The same applies to the second wireless station 20. The analyzer 50 estimates the communication mode and position of the jamming wave on the basis of the notified demodulation error information 5. Note that, the communication mode here refers to a wireless standard defined by IEEE802.11, a communication protocol, or the like.

Hereinafter, the wireless communication system 100 of the present disclosure will be continuously described. However, in order to simplify the description, in a case where it is not necessary to distinguish the radio wave 11 and the radio wave 12, they are referred to as a radio wave 1. In addition, in a case where it is not necessary to distinguish the first wireless station 10 and the second wireless station 20, they are referred to as a wireless station 2. Furthermore, in a case where it is not necessary to distinguish the jamming wave 31 and the jamming wave 41, they are referred to as a jamming wave 3. In addition, in a case where it is not necessary to distinguish the first jamming wireless station 30 and the second jamming wireless station 40, they are referred to as a jamming wireless station 4.

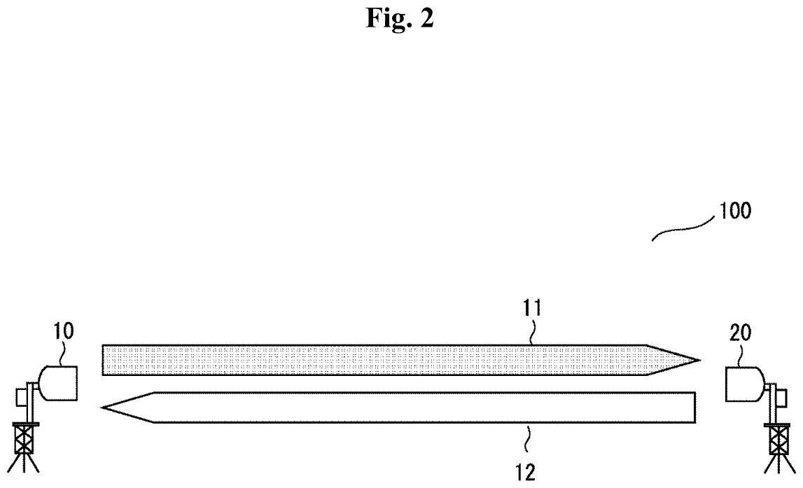

FIG. 2 is a diagram for explaining a transmission mode of the radio wave 1 according to the first embodiment. The radio wave 1 in the fixed wireless communication is continuously transmitted regardless of the presence or absence of transmission data.

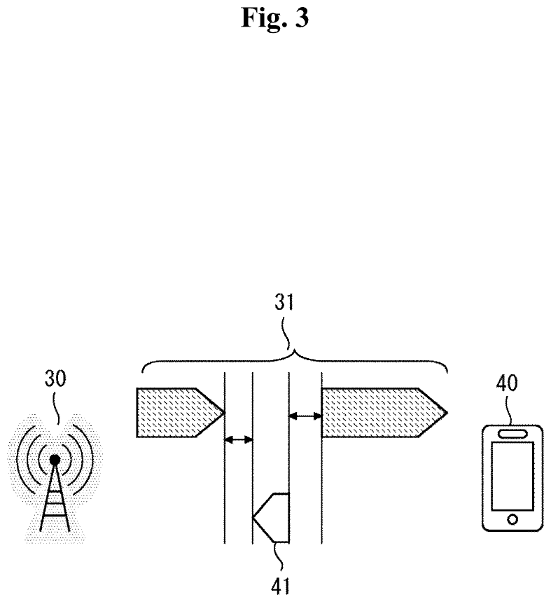

FIG. 3 is a diagram for explaining a transmission mode of the jamming wave 3 according to the first embodiment. Unlike the radio wave 1, the jamming wave 3 is transmitted in an intermittent pattern specific to the communication mode. This is because the packet interval, the communication standby time, and the like according to the communication mode are set in the wireless packet communication. For example, in the wireless LAN, a radio signal called a beacon having a cycle of about 100 ms is transmitted from the base station. In addition, in carrier sense multiple access with collision avoidance (CSMA/CA) algorithm, there is the transmission standby time specific to the algorithm represented by short inter frame space (SIFS) and distributed coordination function inter frame space (DIFS).

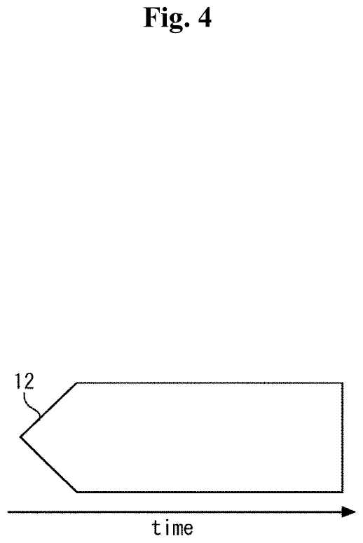

FIG. 4 is a schematic diagram illustrating a state in which the radio wave 12 is demodulated when there is no interference of the jamming wave 3 according to the first embodiment. As the radio wave 12 reaches the first wireless station 10, demodulation is started, and a demodulated signal having a strength corresponding to a radio output of the radio wave 12 is generated. The demodulated signal continues to be generated as long as the radio wave 12 continues to be transmitted and generated. In a case where there is no interference of the jamming wave 3, a normal demodulated signal that changes with time in such a pattern is obtained.

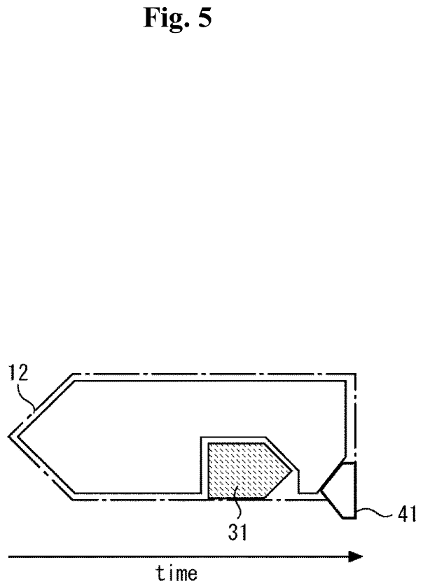

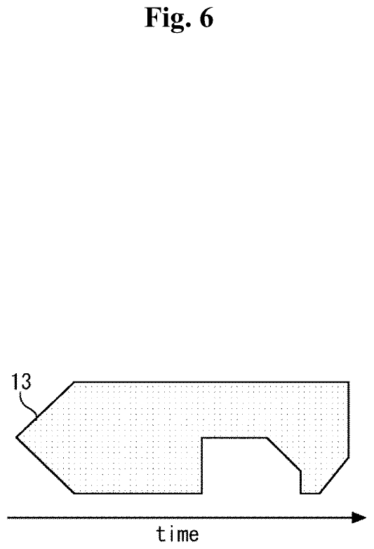

FIGS. 5 and 6 are schematic diagrams illustrating a state in which the radio wave 12 including the jamming wave 31 and the jamming wave 41 is demodulated according to the first embodiment. The radio wave 12 is demodulated in the similar manner to in FIG. 4, but is not normally demodulated in a time region including interference between the jamming wave 31 and the jamming wave 41 as illustrated in FIG. 5. As a result, an abnormal demodulated signal 13 that changes with time in a pattern as illustrated in FIG. 6 is obtained.

Note that, the description of FIGS. 4 to 6 also applies to a case where the second wireless station 20 demodulates the radio wave 11.

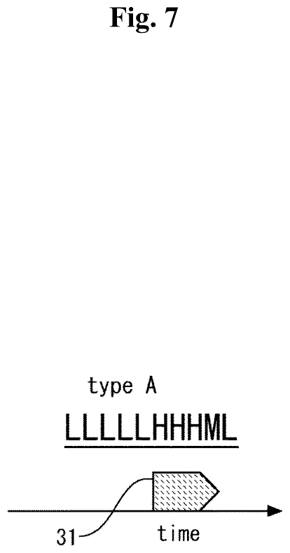

FIG. 7 illustrates a transmission pattern of a radio signal of the communication mode A that can be the jamming wave 31 for fixed wireless communication according to the first embodiment. The vertical axis represents radio signal output indicated by three values of H (high), M (middle), and L (low). The horizontal axis represents elapsed time. The signal output is Low until the transmission is started. When a radio signal starts to be transmitted, the signal output becomes High. Furthermore, immediately before the transmission of the radio signal is completed, the signal output becomes Middle, and returns to Low as the transmission of the radio signal is completed. As a result, the transmission pattern of the communication mode A changes into LLLLLHHHML.

As described above, the jamming wave 31 is transmitted in an intermittent pattern specific to the communication mode. In the example of FIG. 7, the characteristics of the communication mode A appear in a period in which the signal output becomes High.

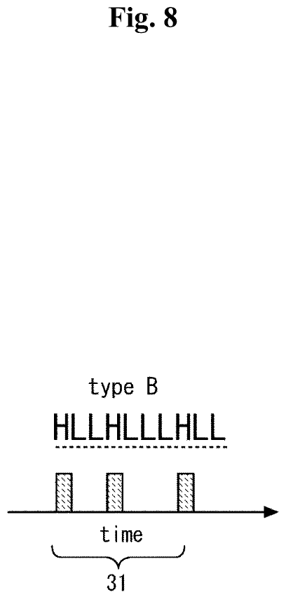

FIG. 8 illustrates a transmission pattern of a radio signal of a communication mode B that can be the jamming wave 31 for fixed wireless communication according to the first embodiment. The vertical axis and the horizontal axis are similar to those in FIG. 7. The transmission pattern of the communication mode B changes into HLLHLLLHLL. Here, the characteristics of the communication mode B appear in the interval time until the signal output becomes High.

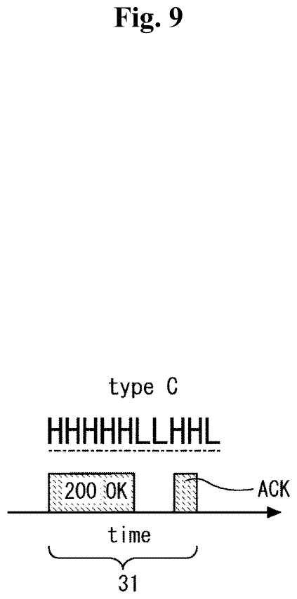

FIG. 9 illustrates a transmission pattern of a radio signal of a communication mode C that can be the jamming wave 31 for fixed wireless communication according to the first embodiment. The vertical axis and the horizontal axis are similar to those in FIG. 7. Here, it is assumed that the communication mode C is a handshake of voice over internet protocol (VOIP). 200 OK and ACK are response signals exchanged between the transmission side and the reception side in VoIP. The signal output of the radio signal also changes with time on the basis of the temporal change pattern of these response signals. The transmission pattern of the communication mode C is HHHHLLHHL.

The analyzer 50 stores, as a template 151, a transmission pattern for each communication mode as illustrated in FIGS. 7 to 9. This makes it possible to compare the demodulation error information 5 notified from the wireless station 2 with the transmission pattern recorded in the template to estimate the communication mode of the jamming wave 3.

In FIGS. 7 to 9, the vertical axis represents three values, but the value of the vertical axis may be continuous. The description of FIGS. 7 to 9 also applies to the jamming wave 41.

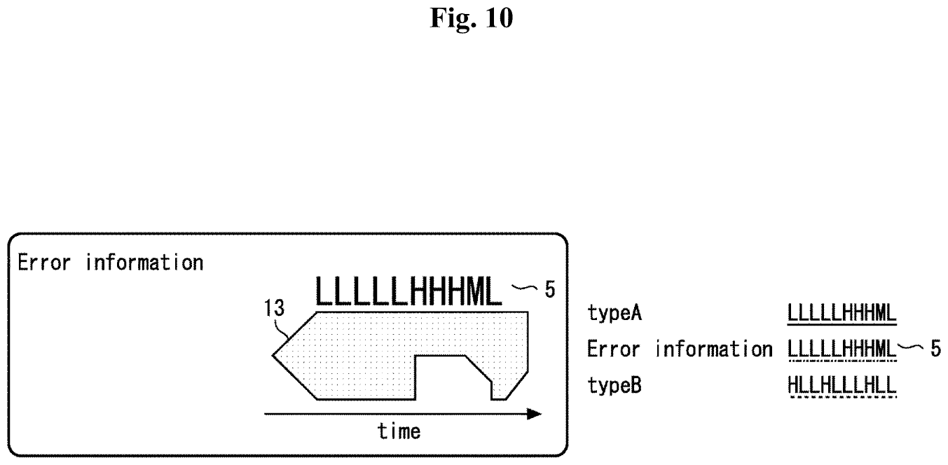

FIG. 10 is a schematic diagram illustrating the demodulation error information 5 of the radio wave 1 according to the first embodiment. The vertical axis indicates the magnitude of the demodulation error indicated by three values of H (high), M (middle), and L (low). The horizontal axis represents elapsed time. The magnitude of the demodulation error changes with time according to the transmission pattern of the jamming wave 3. In the example of FIG. 10, it is changed into LLLLLLLHHHML. The wireless station 2 notifies the analyzer 50 of such a temporal change pattern of the demodulation error as the demodulation error information 5.

The analyzer 50 compares the notified demodulation error information 5 with the transmission pattern recorded in the template 151. In the example of FIG. 10, the demodulation error information 5 changing into LLLLLLLHHHML is compared with the transmission patterns of the communication mode A and the communication mode B. Since the demodulation error information 5 has a high matching rate with the transmission pattern of the communication mode A, it can be estimated that the communication mode of the jamming wave 3 is the communication mode A. For the estimation, machine learning or mathematical analysis may also be used.

Note that, the communication mode that can be estimated by the analyzer 50 is not limited to the above examples, and can be estimated by other communication modes such as a new radio-unlicensed (NR-U) system and a time division duplex (TDD) system in a 5G mobile communication system.

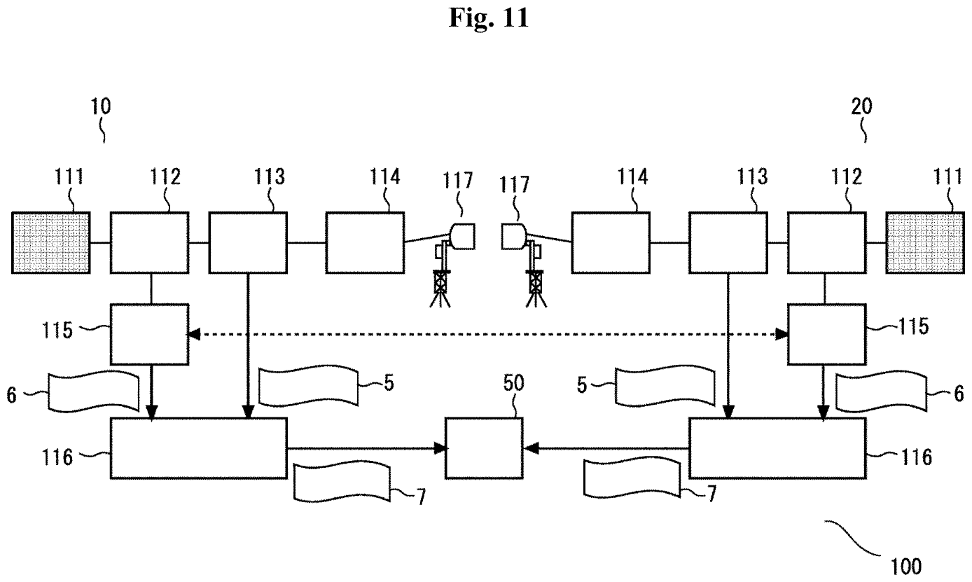

FIG. 11 is a block diagram illustrating a configuration of the wireless communication system 100 according to the first embodiment. In the first wireless station 10, an antenna 117 receives the radio wave 12. A transmission/reception unit 114 is a unit that amplifies, shapes, and the like a high-frequency radio signal. A demodulation unit 113 is a unit that performs analog demodulation. When a demodulation error occurs, the demodulation unit 113 notifies a storage unit 116 of the demodulation error information 5.

An IF unit 112 converts the radio wave 12 having a high frequency into an intermediate frequency (IF) band. A transmission device 111 is an interface that receives a signal from another device.

A time synchronization unit 115 performs time synchronization using a global positioning system (GPS) or the like with the time synchronization unit 115 of the second wireless station 20. Furthermore, synchronized time information 6 is notified to the storage unit 116. The storage unit 116 adds the time information 6 notified from the time synchronization unit 115 to the demodulation error information 5 notified from the demodulation unit 113, and then stores the demodulation error information 5. As a result, it is possible to accurately store the time when the demodulation error occurs in each of the two wireless stations. Hereinafter, the demodulation error information 5 to which the time information 6 is added is referred to as time-added demodulation error information 7. The storage unit 116 notifies the analyzer 50 of the time-added demodulation error information 7.

The storage unit 116 is a storage device such as a hard disk drive or a solid state drive (SSD). These storage devices may not necessarily be built in the first wireless station 10, and may be connected online.

Note that, in the above description, the function has been mainly described in a case where the first wireless station 10 receives the radio wave 12. However, the first wireless station 10 can also transmit the radio wave 11 with the configuration of FIG. 11. In addition, since the above description is also common to the second wireless station 20, the description thereof will be omitted.

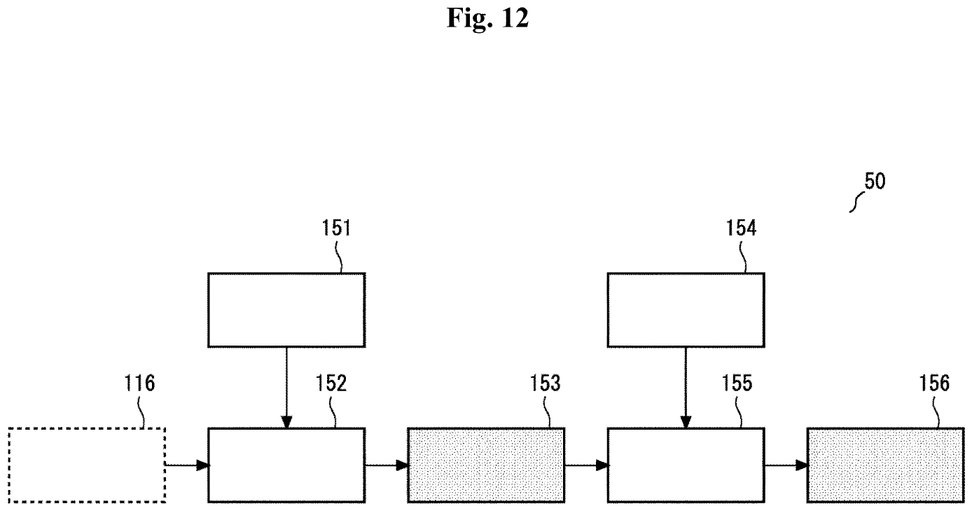

FIG. 12 is a block diagram illustrating a configuration of the analyzer 50 according to the first embodiment. A communication mode estimation unit 152 receives the time-added demodulation error information 7 from the storage unit 116 of the first wireless station 10. Furthermore, the communication mode estimation unit 152 compares the transmission pattern recorded in the template 151 with the demodulation error information 5 included in the time-added demodulation error information 7 to estimate the communication mode of the jamming wave 3. Furthermore, the detection time of the jamming wave 3, which is the cause of the demodulation error, is estimated on the basis of the time information 6 included in the time-added demodulation error information 7. The first storage unit 153 stores the estimation result of the communication mode of the jamming wave 3 and information on the detection time of the jamming wave 3.

In addition, the analyzer 50 estimates the communication mode and the detection time for the jamming wave 3 detected by the second wireless station 20 by a similar method. The information is stored in the second storage unit 154. A calculation unit 155 calculates a detection time difference of the jamming wave 3 in the first wireless station 10 and the second wireless station 20 on the basis of the information of the detection time stored in each of the first storage unit 153 and the second storage unit 154. A position estimating unit 156 estimates the position of the jamming wireless station 4 on the basis of the calculation result of the detection time difference and the position information of the first wireless station 10 and the second wireless station 20.

As described above, in the present embodiment, it is possible to provide the wireless communication system 100 capable of estimating the communication mode of the jamming wave 3 and the position of the jamming wireless station 4.

Here, it should be noted that in the wireless communication system 100 of the present disclosure, the above-described effects can be obtained without stopping the fixed wireless communication. For the fixed wireless communication that continuously transmits the radio wave 1, there is a great advantage that the communication mode of the jamming wave 3 and the position of the jamming wireless station 4 can be estimated without stopping the communication.

In the wireless communication system of the present disclosure, since the communication mode and position of the jamming wave 3 can be specified, the jamming wireless station 4 can be removed even after the wireless station 2 is installed. Therefore, it is possible to omit the interference examination conventionally performed before installation of the wireless station 2.

### First Modification

If the demodulation error information 5 in one of the first wireless station 10 and the second wireless station 20 is present, the analyzer 50 can estimate the communication mode of the jamming wave 3. The time information 6 may not be added to demodulation error information 5. Therefore, when it is not necessary to estimate the position of the jamming wireless station 4, or the like, the demodulation unit 113 of one wireless station 2 may notify the storage unit 116 of the demodulation error information 5. In the wireless station, the time synchronization unit 115 may not be provided. Furthermore, in the analyzer 50, the second storage unit 154, the calculation unit 155, and the position estimating unit 156 may not be provided. This point is common to all the embodiments.

### Second Modification

Note that, the processing performed by the wireless station 2 and the analyzer 50 may be executed by a program using a computer including a CPU and a memory and storing the program in the memory. Alternatively, the processing may be executed by the program using an integrated circuit such as a field programmable gate array (FPGA). Note that, the program may be provided by being recorded in a storage medium, or may be provided through a network. This point is also common to all the following embodiments.

### Third Modification

Note that, the analyzer 50 may be incorporated in either the first wireless station 10 or the second wireless station 20. This point is common to all the embodiments.

### Second Embodiment

In the present embodiment, using the fact that the transmission pattern also changes depending on communication content data included in the jamming wave 3, the content data is estimated. Hereinafter, changing points from the first embodiment will be described.

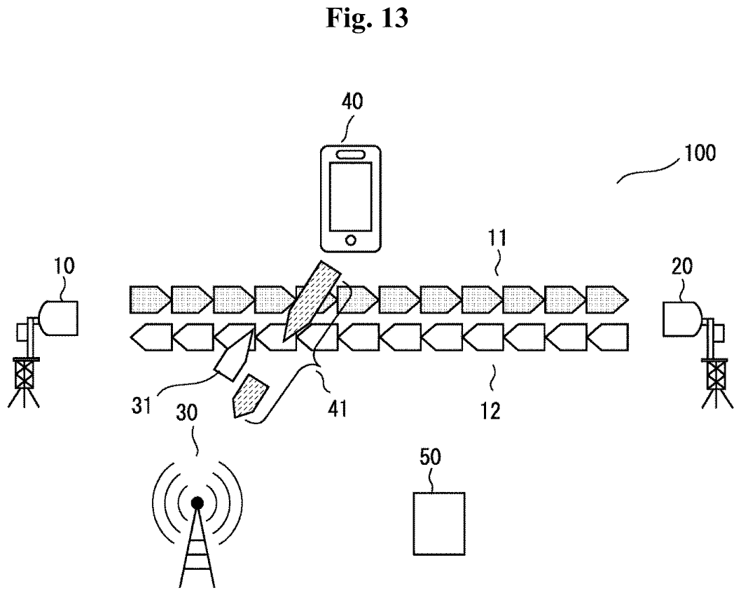

FIG. 13 is a diagram illustrating a configuration example of the wireless communication system 100 according to the second embodiment. The radio wave 11 and the radio wave 12 are continuously transmitted similarly to the first embodiment.

However, in order to simplify the description, here, a plurality of arrows is illustrated in a connected state.

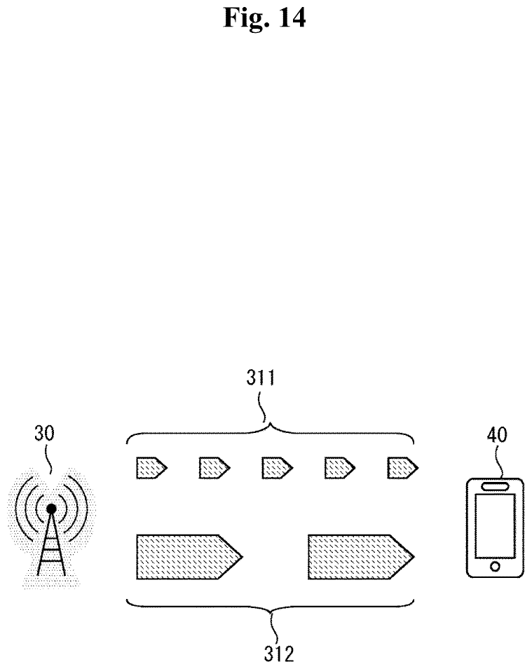

FIG. 14 is a diagram for explaining a relationship between a transmission mode of the jamming wave 3 and content data according to the second embodiment. Similarly to the first embodiment, the jamming wave 3 is transmitted in an intermittent pattern specific to the communication mode. In the present embodiment, the jamming wave 3 includes content data such as voice or a moving image, and is transmitted in a pattern determined for each of the content data.

In the case of voice data 311, a short-time radio signal is repeatedly transmitted with a small output. For example, in the case of VoIP, radio signals are transmitted at intervals of about 20 ms or 40 ms according to the voice codec in the G.711 standard. On the other hand, in the case of moving image data 312, a long-time radio signal is repeatedly transmitted with a large output.

The analyzer 50 stores a transmission pattern for each content data as the template 151.

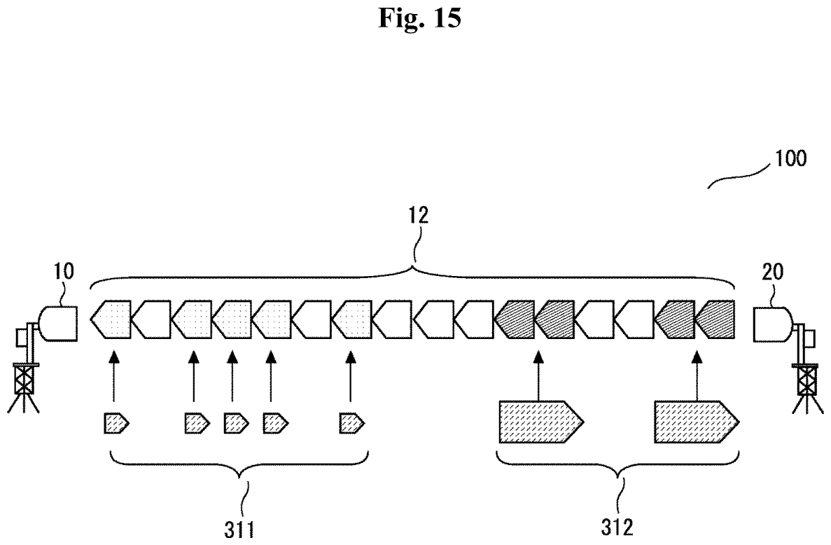

FIG. 15 is a schematic diagram illustrating a relationship between a magnitude of a demodulation error and content data according to the second embodiment. Since the magnitude of the demodulation error depends on the signal output of the jamming wave 3, the ratio (hereinafter, referred to as an error rate) of High as the magnitude of the demodulation error in the demodulation error information 5 increases as the signal output of the jamming wave 3 increases. This means that the error rate depends on the type of content data included in the jamming wave 3. Therefore, while the radio wave 12 is interfered with the jamming wave 3, the demodulation error information 5 having an error rate corresponding to the content data included in the jamming wave 3 is continuously generated.

In the example of FIG. 15, the demodulation error information 5 having a low error rate is continuously generated while the jamming wave 3 including the voice data 311 is transmitted. On the other hand, while the jamming wave 3 including the moving image data 312 is transmitted, the demodulation error information 5 having a high error rate is continuously generated. In the drawing, the color density of an arrow indicating the radio wave 12 indicates the magnitude of the error rate at the time of demodulating the radio wave. A darker color indicates a higher error rate.

The analyzer 50 compares the demodulation error information 5 with the transmission pattern recorded in the template 151 to estimate the communication mode of the jamming wave 3 and the content data included in the jamming wave 3. Since a radio signal including content data such as voice and a moving image is transmitted for a relatively long period of time, the analyzer 50 can continuously analyze the jamming wave 3 including the content data, so that estimation can be performed with high accuracy.

As described above, in the present embodiment, it is possible to provide the wireless communication system 100 capable of estimating the content data included in the jamming wave 3.

### Fourth Modification

Note that, the present disclosure is not limited to the above-described embodiments, and various modifications can be made in the implementation stage without departing from the gist of the present disclosure. In addition, the embodiments may be implemented in appropriate combination, and in that case, a combined effect can be obtained.

### REFERENCE SIGNS LIST

1 Radio wave
2 Wireless station
3 Jamming wave
4 Jamming wireless station
5 Demodulation error information
6 Time information
7 Time-added demodulation error information
10 First wireless station
11 Radio wave
12 Radio wave
13 Abnormal demodulated signal
20 Second wireless station
30 First jamming wireless station
31 Jamming wave
40 Second jamming wireless station
41 Jamming wave
50 Analyzer
100 Wireless communication system
111 Transmission device
112 IF unit
113 Demodulation unit
114 Transmission/reception unit
115 Time synchronization unit
116 Storage unit
117 Antenna
151 Template
152 Communication mode estimation unit
153 First storage unit
154 Second storage unit
155 Calculation unit
156 Position estimating unit
311 Voice data
312 Moving image data

1. A wireless communication system comprising:
a first wireless station;
a second wireless station configured to perform wireless communication with the first wireless station by a continuous wireless radio wave; and
an analyzer,
wherein
at least one of the first wireless station and the second wireless station is configured to execute:
demodulating the received radio wave; and
notifying the analyzer of a temporal change pattern of a magnitude of a demodulation error as demodulation error information, and
the analyzer is configured to execute:
storing a temporal change pattern of a radio signal in wireless packet communication capable of interfering with the wireless communication as a transmission pattern for each communication mode;
comparing the demodulation error information with the transmission pattern; and
estimating a communication mode having a transmission pattern having a high matching rate with the demodulation error information as a communication mode of a jamming wave for the wireless communication.

2. The wireless communication system according to claim 1, wherein
the demodulating and the notifying are executed by both the first wireless station and the second wireless station,
the first wireless station and the second wireless station add time information to the demodulation error information and notify the analyzer of the demodulation error information, and
the analyzer is configured to further execute:
calculating a detection time difference of a jamming wave in the first wireless station and the second wireless station on a basis of the time information notified from the first wireless station and the time information notified from the second wireless station; and
estimating a position of a jamming wireless station that transmits the jamming wave on a basis of a calculation result of the detection time difference and position information of the first wireless station and the second wireless station.

3. The wireless communication system according to claim 2, wherein
the first wireless station and the second wireless station further execute synchronizing time with each other, and
the time information is time synchronized between the first wireless station and the second wireless station.

4. The wireless communication system according to claim 1, wherein
the communication mode of the transmission pattern includes a communication mode defined for content data, and
the comparing further includes estimating content data included in the jamming wave from a communication mode of the jamming wave.

5. An analyzer used together with two wireless stations configured to perform wireless communication by continuous radio waves, the analyzer is configured to execute:
receiving, from at least one of the two wireless stations, a temporal change pattern of a magnitude of an error that occurs during demodulation of the radio wave as demodulation error information;
storing a temporal change pattern of a radio signal in wireless packet communication capable of interfering with the wireless communication as a transmission pattern for each communication mode;
comparing the demodulation error information with the transmission pattern; and
estimating a communication mode having a transmission pattern having a high matching rate with the demodulation error information as a communication mode of a jamming wave for the wireless communication.

6. The analyzer according to claim 5, further comprising:
receiving the demodulation error information to which time information is added from both of the two wireless stations, the analyzer is configured to further execute:
calculating a detection time difference of a jamming wave in the two wireless stations on a basis of time information notified from each of the two wireless stations; and
estimating a position of a jamming wireless station that transmits the jamming wave on a basis of a calculation result of the detection time difference and position information of the two wireless stations.

7. A wireless communication method comprising:
demodulating, by at least one of a first wireless station and a second wireless station that perform wireless communication with each other by continuous radio waves, the received radio wave;
notifying, by at least one of the first wireless station and the second wireless station, an analyzer of a temporal change pattern of a magnitude of a demodulation error as demodulation error information;
storing, by the analyzer, a temporal change pattern of a radio signal in wireless packet communication capable of interfering with the wireless communication as a transmission pattern for each communication mode;
comparing, by the analyzer, the demodulation error information with the transmission pattern; and
estimating, by the analyzer, a communication mode having a transmission pattern having a high matching rate with the demodulation error information as a communication mode of a jamming wave for the wireless communication.

8. A storage medium storing a computer readable analysis program which is executed by a computer, the computer readable analysis program being configured to cause the computer to function as the analyzer according to claim 5.

9. The wireless communication system according to claim 2, wherein
the communication mode of the transmission pattern includes a communication mode defined for content data, and
the comparing further includes estimating content data included in the jamming wave from a communication mode of the jamming wave.

10. The wireless communication system according to claim 3, wherein
the communication mode of the transmission pattern includes a communication mode defined for content data, and
the comparing further includes estimating content data included in the jamming wave from a communication mode of the jamming wave.
